(19) United States
(12) Patent Application Publication
(10) Pub. No.: US 2016/0061164 A1
(43) Pub. Date: Mar. 3, 2016

(54) VACUUM PRODUCER INCLUDING AN ASPIRATOR AND AN EJECTOR

(71) Applicants: David E. Fletcher, Flint, MI (US); Brian M. Graichen, Leonard, MI (US); Keith Hampton, Ann Arbor, MI (US)

(72) Inventors: David E. Fletcher, Flint, MI (US); Brian M. Graichen, Leonard, MI (US); Keith Hampton, Ann Arbor, MI (US)

(73) Assignee: DAYCO IP HOLDINGS, LLC, Springfield, MO (US)

(21) Appl. No.: 14/468,446

(22) Filed: Aug. 26, 2014

(51) Int. Cl. F02M 35/10; F02M 25/07

(52) U.S. Cl. CPC F02M 35/10163; F02M 25/0706

(57) ABSTRACT

A vacuum producer for supplying vacuum to a device in a boosted engine air system is disclosed. The boosted engine air system includes a throttle. The vacuum producer includes a first engine connection, a second engine connection, an aspirator, an aspirator check valve, an ejector, and an ejector check valve. The first engine connection is fluidly connected to atmospheric pressure and the second engine connection is fluidly connected to the engine air system at a location upstream of an intake manifold of an engine and downstream of the throttle. The aspirator provides vacuum to the device if pressure at the intake manifold is below atmospheric pressure. The ejector provides vacuum if pressure at the intake manifold is above atmospheric pressure.

### TECHNICAL FIELD

This application relates to a vacuum producer for a boosted engine, and in particular to a low-cost vacuum producer including an aspirator as well as an ejector for supplying vacuum to a device.

### BACKGROUND

In some vehicles vacuum is used to operate or assist in the operation of various devices. For example, vacuum may be used to assist a driver applying vehicle brakes, turbocharger operation, fuel vapor purging, heating and ventilation system actuation, and driveline component actuation. If the vehicle does not produce vacuum naturally, such as from the intake manifold, then a separate vacuum source is required to operate such devices. For example, in some boosted engines where intake manifold pressures are often at pressures greater than atmospheric pressure, intake manifold vacuum may be replaced or augmented with vacuum from an aspirator.

As used herein, an aspirator is defined as a converging, diverging nozzle assembly with three connections, a motive port connected to the intake air at atmospheric pressure, a discharge port connected to the manifold vacuum located downstream of the throttle, and a suction port connected to a device requiring vacuum. A low pressure region may be created within the aspirator so that air can be drawn from a vacuum reservoir or may directly act on a device requiring vacuum, thereby reducing pressure within the vacuum reservoir or device requiring vacuum.

A control valve may be used to shut off or stop compressed air from flowing through the aspirator if the engine is operating under boosted pressures. Specifically, the control valve is used to prevent compressed air located at the intake manifold from flowing through the aspirator, and back into the intake air, which is at atmospheric pressure. However, several drawbacks exist when using this approach. Specifically, the aspirator may only be able to provide vacuum if the engine is not operating under boosted pressures, since the control valve shuts off the flow of compressed air when the engine operates under boosted pressures. Moreover, the control valve is typically an expensive component that adds significantly to the overall cost of the system. Thus, there is a continuing need in the art for an improved, cost-effective vacuum producer for use in a boosted engine.

### SUMMARY

In one aspect, the disclosed vacuum producer is used in a boosted engine, and includes an aspirator and an ejector. The aspirator of the vacuum producer may be used to supply vacuum if the pressure at an intake manifold of the engine is less than atmosphere. The ejector of the vacuum producer may be used to supply vacuum if the pressure at the intake manifold of the engine is greater than atmosphere. The disclosed vacuum producer also employs relatively inexpensive check valves for allowing airflow in only one direction through the aspirator and the ejector.

In one embodiment, a vacuum producer for supplying vacuum to a device in a boosted engine air system is disclosed. The boosted engine air system includes a throttle. The vacuum producer includes a first engine connection, a second engine connection, an aspirator, an aspirator check valve, an ejector, and an ejector check valve. The first engine connection is fluidly connected to atmospheric pressure and the second engine connection is fluidly connected to the engine air system at a location upstream of an intake manifold of an engine and downstream of the throttle. The aspirator is fluidly connected to the device, the first engine connection, and the intake manifold, and provides vacuum to the device if pressure at the intake manifold is below atmospheric pressure. The ejector is fluidly connected to the device, the second engine connection, and the intake manifold, and provides vacuum if pressure at the intake manifold is above atmospheric pressure. The aspirator check valve is fluidly connected to the aspirator and substantially prevents air from flowing through the aspirator if pressure at the intake manifold is above atmospheric pressure. The ejector check valve is fluidly connected to the ejector and substantially prevents air from flowing through the ejector if pressure at the intake manifold is below atmospheric pressure.

In another embodiment, a turbocharged engine air system is disclosed and includes a device requiring vacuum, a turbocharger having a compressor fluidly connected to an intake manifold of an engine, a throttle and a vacuum producer. The throttle is located upstream of the intake manifold of the engine and downstream of the compressor. The vacuum producer includes a first engine connection, a second engine connection, an aspirator, an aspirator check valve, an ejector, and an ejector check valve. The first engine connection is fluidly connected to atmospheric pressure and the second engine connection is fluidly connected to the engine air system at a location upstream of the intake manifold of the engine and downstream of the throttle. The aspirator is fluidly connected to the device, the first engine connection, and the intake manifold, and provides vacuum to the device if pressure at the intake manifold is below atmospheric pressure. The ejector is fluidly connected to the device, the second engine connection, and the intake manifold, and provides vacuum if pressure at the intake manifold is above atmospheric pressure. The aspirator check valve is fluidly connected to the aspirator and substantially prevents air from flowing through the aspirator if pressure at the intake manifold is above atmospheric pressure. The ejector check valve is fluidly connected to the ejector and substantially prevents air from flowing through the ejector if pressure at the intake manifold is below atmospheric pressure.

### BRIEF DESCRIPTION OF THE DRAWINGS

FIG. 1 is a schematic diagram including flow paths and flow directions of one embodiment of an internal combustion engine turbo system including a vacuum producer.

FIG. 2 is a schematic diagram of the vacuum producer shown in FIG. 1, where the vacuum producer includes an aspirator and an ejector.

FIG. 3 is an illustration of the aspirator shown in FIG. 2.

FIG. 4 is a table summarizing various operating conditions of the internal combustion engine turbo system shown in FIG. 1 when a throttle is opened and closed.

FIG. 5 is an alternative embodiment of the vacuum producer shown in FIG. 2, where the aspirator includes a bypass port.

### DETAILED DESCRIPTION

The following detailed description will illustrate the general principles of the invention, examples of which are additionally illustrated in the accompanying drawings. In the drawings, like reference numbers indicate identical or functionally similar elements. As used herein, the term fluid may include any liquid, suspension, colloid, gas, plasma, or combinations thereof.

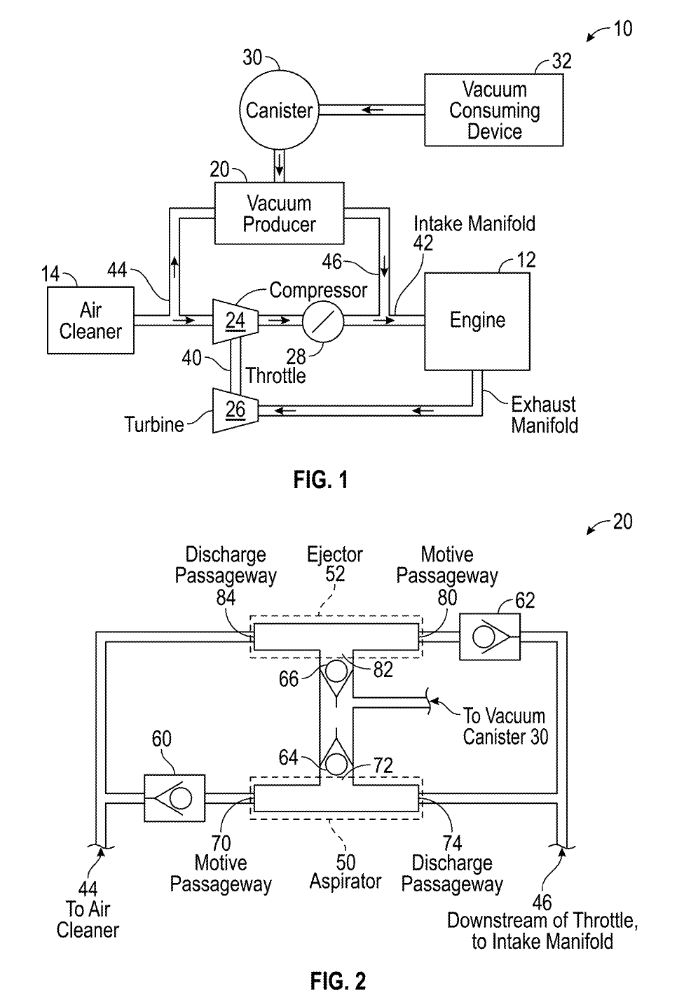

Referring now to FIG. 1, an exemplary turbocharged engine air system 10 for providing vacuum to a vehicle vacuum system is disclosed. The engine air system 10 may include an internal combustion engine 12, an air cleaner 14, a vacuum producer 20, a compressor 24, a turbine 26, a throttle 28, a vacuum reservoir or canister 30, and a vacuum consuming device 32. The internal combustion engine 12 may be, for example, a spark ignited (SI) engine, a compression ignition (CI) engine, or a natural gas engine. In one embodiment, the internal combustion engine 12 may be included in an electric motor/battery system that is part of a hybrid vehicle. The throttle 28 may be located downstream of the air cleaner 14 and the compressor 24, and upstream of an intake manifold 42 of the internal combustion engine 12.

In the embodiment as shown in FIG. 1, the internal combustion engine 12 is boosted. This means that the compressor 24 and turbine 26 may be part of a turbocharger for improving the power output and overall efficiency of the internal combustion engine 12. The turbine 26 may include a turbine wheel (not illustrated in FIG. 1) that harnesses and converts exhaust energy into mechanical work through a common shaft 40 to turn a compressor wheel (not illustrated in FIG. 1) of the compressor 24. The compressor wheel ingests, compresses, and feeds air at elevated operating pressures into the intake manifold 42 of the internal combustion engine 12.

The vacuum canister 30 may be supplied vacuum from the vacuum producer 20. The vacuum producer 20 is supplied clean air from the air cleaner 14. The air cleaner 14 is positioned upstream of both the compressor 24 and the throttle 28. The clean air passes through the vacuum producer 20 and provides a vacuum source for the vacuum canister 30. Specifically, as explained in greater detail below, the vacuum producer 20 may be used to supply vacuum to the vacuum canister 30, regardless of the position of the throttle 28. The throttle 28 may be opened as an operator depresses upon an accelerator pedal (not shown). When the throttle 28 is opened, compressed air from the compressor 24 is free to fill the intake manifold 42 of the internal combustion engine 12, thereby increasing the pressure at the intake manifold 42. Those skilled in the art will appreciate that the throttle 28 may be positioned in a plurality of partially opened positions based on the amount of depression of the accelerator (not shown). Since the engine air system 10 is turbocharged, the pressure at the intake manifold 42 may increase to a pressure that is above atmosphere as the throttle 28 is opened.

The vacuum producer 20 may include an engine air connection 44, an engine air connection 46, an aspirator 50 (shown in FIG. 2) and an ejector 52 (also shown in FIG. 2). The engine air connection 44 of the vacuum producer 20 may be fluidly connected to the engine air system 10 at a location upstream of the compressor 24 and downstream of the air cleaner 14. The engine air connection 46 of the vacuum producer 20 may be fluidly connected to the engine air system 10 at a location upstream of the intake manifold 42 and downstream of the throttle 28. The aspirator 50 may be used to supply vacuum to the vacuum canister 30 if the pressure at the intake manifold 42 is less than atmosphere. The ejector 52 may be used to supply vacuum to the vacuum canister 30 if the pressure at the intake manifold 42 is greater than atmosphere. In an alternative embodiment, the vacuum producer 20 may directly supply vacuum to the vacuum consuming device 32.

The vacuum consuming device 32 may be a device requiring vacuum, such as a brake booster. In an embodiment, the vacuum consuming device 32 may also include additional vacuum consumers as well, such as, for example, turbocharger waste gate actuators, heating and ventilation actuators, driveline actuators (e.g., four wheel drive actuators), fuel vapor purging systems, engine crankcase ventilation, and fuel system leak testing systems.

FIG. 2 is a schematic diagram of one embodiment of the vacuum producer 20 shown in FIG. 1, and illustrates the aspirator 50 as well as the ejector 52. The vacuum producer 20 may also include an aspirator check valve 60, an ejector check valve 62, an aspirator suction side check valve 64, and an ejector suction side check valve 66. It is to be understood that the illustration shown in FIG. 2 is merely one embodiment of the vacuum producer 20, and that the vacuum producer 20 should not be limited in scope by the arrangement as shown in the figures. As described in greater detail below, the aspirator check valve 60, the ejector check valve 62, the first suction side check valve 64, and the second suction side check valve 66 may be arranged in a variety of configurations.

Referring to FIGS. 1 and 2, as used herein, the aspirator 50 may be a converging, diverging nozzle assembly with three connections. The aspirator 50 may include a motive port 70 fluidly connected to atmospheric pressure, a discharge port 74 fluidly connected to the manifold vacuum located downstream of the throttle 28, and a suction port 72 fluidly connected to the vacuum canister 30. Specifically, the motive port 70 of the aspirator 50 may be fluidly connected to the engine air system 10 at the engine air connection 44 of the vacuum producer 20, and the discharge port 74 of the aspirator 50 may be fluidly connected to the engine air system at the engine air connection 46 of the vacuum producer 46. Similarly, the ejector 52 as used herein, may also be a converging, diverging nozzle assembly with three connections. The ejector 52 may include a motive port 80 fluidly connected to the manifold vacuum located downstream of the throttle 28, a discharge port 84 fluidly connected to atmospheric pressure, and a suction port 82 fluidly connected to the vacuum canister 30. Specifically, the motive port 80 may be fluidly connected to the engine air system 10 at the engine air connection 46 of the vacuum producer 20 and the discharge port 84 of the ejector 52 may be fluidly connected to the engine air system 10 at the engine air connection 44 of the vacuum producer 20.

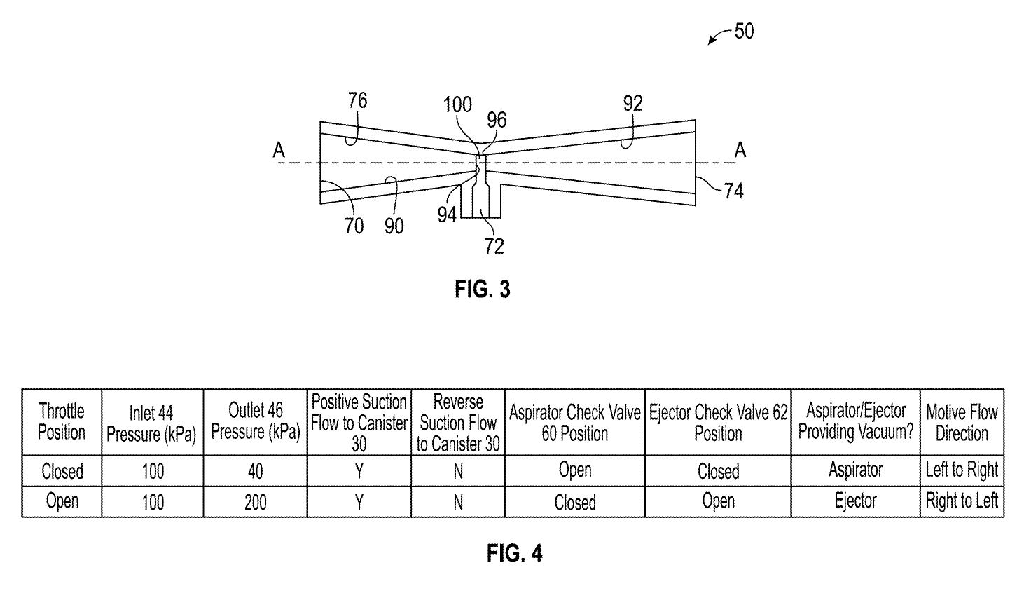

Referring to FIGS. 1-3, the aspirator 50 creates a vacuum that is supplied to the vacuum canister 30 by the flow of clean air from the air cleaner 14 through a passageway 76 (shown in FIG. 3). The passageway 76 of the aspirator 50 may generally extend the length of the aspirator 50, and is configured to create the Venturi effect. The motive inlet 70 of the aspirator 50 is fluidly connected to the air cleaner 14 by the aspirator check valve 60. The suction port 72 of the aspirator 50 is fluidly connected to the vacuum canister 30 by the aspirator suction side check valve 64. The discharge outlet 74 of the aspirator 50 is fluidly connected to the intake manifold 42.

Referring to FIG. 3, the aspirator 50 may be generally “T-shaped” and defines the passageway 76 along a central axis A-A. The passageway 76 may include a first tapering portion or motive cone 90 coupled to a second tapering portion or discharge cone 92. In the embodiment as shown, the first tapering portion 90 includes a tapered converging profile, and the second tapered portion 92 includes a diverging profile. The first tapering portion 90 and the second tapering portion 92 may be aligned end to end, where a motive outlet end 94 of the motive cone 90 faces a discharge inlet 96 of the discharge cone 92 to define a Venturi gap 100 therebetween. The Venturi gap 100 as used herein means the lineal distance between the motive outlet end 94 and the discharge inlet 96. Some exemplary configurations for the aspirator 50 are presented in FIGS. 4-6 of co-pending U.S. patent application Ser. No. 14/294,727, filed on Jun. 3, 2014 as well as U.S. patent application Ser. No. 14/452,651 filed on Aug. 6, 2014, which are both incorporated by reference herein in their entirety. Moreover, although the aspirator 50 is described and illustrated in FIG. 3, those skilled in the art will readily appreciate that the ejector 52 shown in FIG. 2 may also include a similar structure. Specifically, the ejector 52 may also include a converging diverging profile, as well as a Venturi gap defined therebetween.

Referring to FIGS. 1-3, in one approach the aspirator check valve 60 may be located between the air cleaner 14 and the motive inlet 70 of the aspirator 50. The aspirator check valve 60 allows for clean air from the air cleaner 14 to flow into the motive inlet 70 of the aspirator 50, and blocks air from flowing in the opposing direction and back into the air cleaner 14 (i.e., the aspirator check valve 60 allows for clean air to only flow from left to right). In other words, the aspirator check valve 60 allows for air at atmospheric pressure to flow from the air cleaner 14, into the aspirator 50, and to the intake manifold 42 when the pressure at the intake manifold 42 is below atmospheric pressure. The aspirator check valve 60 also prevents reverse air from the intake manifold 42 from flowing back into the air cleaner 14 when the pressure at the intake manifold 42 is above atmospheric pressure. That is, the aspirator check valve 60 prevents compressed air from flowing back into the air cleaner 14.

Although FIG. 2 illustrates the aspirator check valve 60 fluidly connected to the air cleaner 14 and located upstream of the aspirator 50, it is to be understood that in an alternative embodiment the aspirator check valve 60 may be located downstream of the aspirator 50. Specifically, the aspirator check valve 60 may be located between the discharge outlet 74 of the aspirator 50 and the intake manifold 42 of the internal combustion engine 12 (FIG. 1). Those skilled in the art will readily appreciate that the aspirator check valve 60 should be arranged or oriented to only allow for air to flow from a high pressure area to a low pressure area. Thus, in the embodiment as shown in FIG. 2, the aspirator check valve 60 should be arranged such that air is only allowed to flow from the air cleaner 14 (which is typically at atmosphere) and to the intake manifold 42 of the engine 12 during non-boosted conditions (i.e., pressure at the intake manifold is below atmosphere).

Referring to FIGS. 1-3, during operation of the engine air system 10 clean air from the air cleaner 14 at atmospheric pressure may enter the aspirator 50 through the motive port 70 when the throttle 28 is closed. As the air flows through the motive port 70, which includes a converging profile that decreases in area, the velocity of the compressed air may increase. This is because the laws of fluid mechanics state that the static pressure decreases as fluid velocity increases. The motive outlet end 96 of the motive cone 92 may abut the Venturi gap 100. The Venturi gap 100 may be fluidly connected to the suction port 72, which exposes the compressed air in the suction port 72 to the same low static pressure that exists in the air that passes between the motive inlet 70 and the discharge outlet 74 and creates the vacuum that is provided to the vacuum canister 30.

As seen in FIG. 2, the aspirator suction side check valve 64 may be positioned between the suction port 72 of the aspirator 50 and the vacuum canister 30 (shown in FIG. 1). The aspirator suction side check valve 64 may ensure that air does not pass from the aspirator 50 to the vacuum canister 30 or to the vacuum consuming device 32, thereby creating reverse suction flow. Similarly, the ejector suction side check valve 66 may be positioned between the suction port 82 of the ejector 52 and the vacuum canister 30 (shown in FIG. 1). The ejector suction side check valve 66 may ensure that air does not pass from the ejector 52 to the vacuum canister 30 or to the vacuum consuming device 32, thereby creating reverse suction flow.

Referring to FIGS. 1-2, the ejector check valve 62 may be located between the intake manifold 42 (FIG. 1) and the motive inlet 80 of the ejector 52. The ejector check valve 62 allows for air above atmospheric pressure from the intake manifold 42 (FIG. 1) to flow into the motive inlet 80 of the ejector 52, and blocks air from flowing in the opposing direction and back into the intake manifold 42 (i.e., air may only flow from right to left). In other words, the ejector check valve 62 allows for air to flow from the intake manifold 42 and back to the air cleaner 14 when the pressure at the intake manifold 42 of the engine is above atmospheric pressure. The ejector check valve 62 also prevents air from the air cleaner 14 from flowing back into the intake manifold 42 when the pressure is below atmospheric pressure at the intake manifold 42 of the engine 12.

Although FIG. 2 illustrates the ejector check valve 62 fluidly connected to the intake manifold 42 and located upstream of the ejector 52, it is to be understood that in an alternative embodiment the ejector check valve 62 may be located downstream of the ejector 52. Specifically, the ejector check valve 62 may be located between the discharge outlet 84 of the ejector 52 and the air cleaner 14 (FIG. 1). Those skilled in the art will readily appreciate that the ejector check valve 62 should be arranged or oriented to only allow for air to flow from a high pressure area to a low pressure area. Thus, in the embodiment as shown in FIG. 2, the ejector check valve 62 should be arranged such that air is only allowed to flow from the intake manifold 42 of the engine 12 during boosted conditions (i.e., pressure at the intake manifold is above atmosphere) and to the air cleaner 14.

The table shown in FIG. 4 summarizes one exemplary set of operating conditions of the vacuum producer 20 shown in FIG. 2 when the throttle 28 (shown in FIG. 1) is either opened or closed. Specifically, the table shown in FIG. 4 summarizes the pressures at the engine air connection 44 and the engine air connection 46 of the vacuum producer 20, whether a positive suction flow is created, whether reverse suction flow is created, the aspirator check valve 60 position, the ejector check valve 62 position, whether the aspirator 50 or the ejector 52 provides vacuum to the vacuum canister 30 (shown in FIG. 1), and the direction of motive flow through the vacuum producer 20. Positive suction flow means that there is air flowing away from the vacuum canister 30 (FIG. 1) to either the aspirator 50 or the ejector 52, thereby creating suction within the vacuum canister 30. Reverse suction airflow means that there is substantially no air flowing from the aspirator 50 or the ejector 52 and into the vacuum canister 30.

Operation of the vacuum producer 20 may now be explained with reference to FIGS. 1, 2 and 4. When the throttle 28 is closed, the pressure at the intake manifold 42 is below atmospheric pressure. Specifically, in the table shown in FIG. 4 the pressure at the engine air connection 44 of the vacuum producer 20 may be substantially at atmospheric pressure (about 100 kilopascals), and the pressure at the engine air connection 46 of the vacuum producer 20 (which is adjacent the intake manifold 42) may be below atmospheric pressure (about forty kilopascals). When the throttle 28 is closed and the pressure at the intake manifold 42 is below atmospheric pressure, the aspirator check valve 60 is open, thereby allowing air to flow through the aspirator 50. Likewise, the ejector check valve 62 is closed, thereby preventing air from flowing through the ejector 52. As a result, the aspirator 50 supplies suction to the vacuum producer 20 when the throttle 28 is closed.

When the throttle 28 is opened, compressed air from the compressor 24 is free to fill the intake manifold 42 of the internal combustion engine 12, thereby increasing the pressure at the intake manifold 42 to a level that is above atmospheric pressure. For example, in one embodiment the pressure at the engine air connection 44 of the vacuum producer 20 may be at atmospheric pressure and the pressure at the engine air connection 46 of the vacuum producer 20 (which is adjacent the intake manifold 42) may be about 200 kilopascals. When the throttle 28 is opened, the ejector check valve 62 is opened, thereby allowing air to flow through the ejector 52. Likewise, the aspirator check valve 60 is closed, thereby preventing air from flowing through aspirator 50. As a result, the ejector 52 may be used to supply suction to the vacuum producer 20 when the throttle 28 is open.

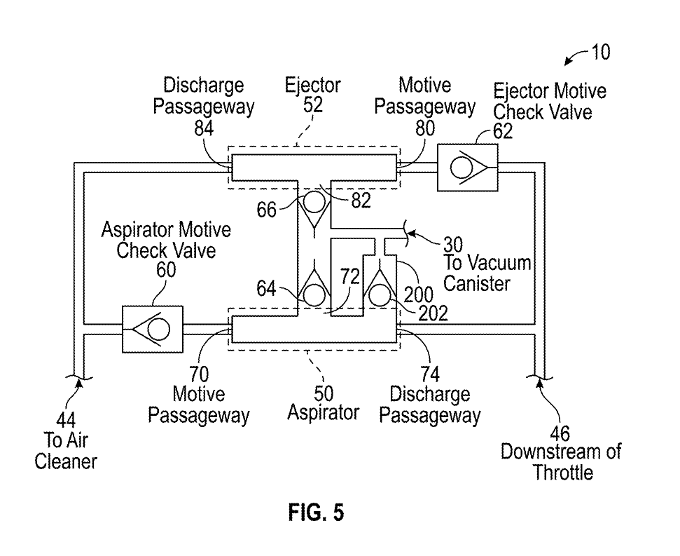

FIG. 5 is an alternative illustration of the vacuum producer 20, where the aspirator 50 includes an optional bypass port 200 for supplying vacuum to the vacuum canister 30 shown in FIG. 1. As seen in FIG. 5, the bypass port 200 is located downstream of the suction port 72, and is fluidly connected to the vacuum canister 30 shown in FIG. 1. A bypass check valve 202 may be located in the fluid pathway between the bypass port 200 and the vacuum canister 30, and is used to prevent air from the aspirator 50 from flowing into the canister 30.

Referring generally to the figures, the disclosed vacuum producer includes a low-cost approach for providing vacuum to a device. Specifically, the aspirator of the vacuum producer may be used to supply vacuum if the pressure at the intake manifold of the engine is less than atmosphere. The ejector of the vacuum producer may be used to supply vacuum if the pressure at the intake manifold of the engine is greater than atmosphere. Some types of engine air systems currently available utilize an aspirator as well as a relatively expensive control valve for providing vacuum to a vacuum canister. These current systems are unable to supply vacuum when the engine is operating under boosted pressures. In contrast, the disclosed vacuum producer includes relatively inexpensive check valves instead of a control valve for allowing airflow in only one direction through the aspirator and the ejector. Moreover, the disclosed vacuum producer also supplies vacuum if the engine is operating under part load as well as boost.

The embodiments of this invention shown in the drawings and described above are exemplary of numerous embodiments that may be made within the scope of the appended claims. It is contemplated that numerous other configurations of the disclosure may be created taking advantage of the disclosed approach. In short, it is the applicants' intention that the scope of the patent issuing herefrom will be limited only by the scope of the appended claims.

What is claimed is:

1. A vacuum producer for providing vacuum to a device in a boosted engine air system, wherein the boosted engine air system includes a throttle, the vacuum producer comprising:
a first engine connection and a second engine connection, the first engine connection fluidly connected to atmospheric pressure and the second engine connection fluidly connected to the engine air system at a location upstream of an intake manifold of an engine and downstream of the throttle;
an aspirator fluidly connected to the device, the first engine connection, and the intake manifold, the aspirator providing vacuum to the device if pressure at the intake manifold is below atmospheric pressure;
an aspirator check valve fluidly connected to the aspirator and substantially preventing air from flowing through the aspirator if pressure at the intake manifold is above atmospheric pressure;
an ejector fluidly connected to the device, the second engine connection, and the intake manifold, the ejector providing vacuum if pressure at the intake manifold is above atmospheric pressure; and
an ejector check valve fluidly connected to the ejector and substantially preventing air from flowing through the ejector if pressure at the intake manifold is below atmospheric pressure.

2. The vacuum producer in claim 1, wherein the aspirator includes a motive port, a discharge port, and a suction port.

3. The vacuum producer in claim 2, wherein the motive port of the aspirator is fluidly connected to atmospheric pressure, the discharge port of the aspirator is fluidly connected to the intake manifold, and the suction port of the aspirator is fluidly connected to the device.

4. The vacuum producer in claim 3, comprising a check valve located between the suction port of the aspirator and the device.

5. The vacuum producer in claim 1, wherein the ejector includes a motive port, a discharge port, and a suction port.

6. The vacuum producer in claim 5, wherein the motive port of the ejector is fluidly connected to the intake manifold, the discharge port of the ejector is fluidly connected to atmospheric pressure, and the suction port of the ejector is fluidly connected to the device.

7. The vacuum producer in claim 6, comprising a check valve located between the suction port of the ejector and the device.

8. The vacuum producer in claim 1, wherein the aspirator check valve is fluidly connected to a motive inlet of the aspirator.

9. The vacuum producer in claim 1, wherein the ejector check valve is fluidly connected to a motive inlet of the ejector.

10. The vacuum producer in claim 1, wherein the aspirator includes a bypass port fluidly connected to the device.

11. A turbocharged engine air system, comprising:
a device requiring vacuum;
a turbocharger having a compressor fluidly connected to an intake manifold of an engine;
a throttle located upstream of the intake manifold of the engine and downstream of the compressor; and
a vacuum producer, comprising:
a first engine connection and a second engine connection, the first engine connection fluidly connected to atmospheric pressure and the second engine connection fluidly connected to the engine air system at a location upstream of the intake manifold of an engine and downstream of the throttle;
an aspirator fluidly connected to the device, the first engine connection, and the intake manifold, the aspirator providing vacuum to the device if pressure at the intake manifold is below atmospheric pressure;
an aspirator check valve fluidly connected to the aspirator and substantially preventing air from flowing through the aspirator if pressure at the intake manifold is above atmospheric pressure;
an ejector fluidly connected to the device, the second engine connection, and the intake manifold, the ejector providing vacuum if pressure at the intake manifold is above atmospheric pressure; and
an ejector check valve fluidly connected to the ejector and substantially preventing air from flowing through the ejector if pressure at the intake manifold is below atmospheric pressure.

12. The turbocharged engine air system in claim 11, wherein the aspirator includes a motive port, a discharge port, and a suction port.

13. The turbocharged engine air system in claim 12, wherein the motive port of the aspirator is fluidly connected to atmospheric pressure, the discharge port of the aspirator is fluidly connected to the intake manifold, and the suction port of the aspirator is fluidly connected to the device.

14. The turbocharged engine air system in claim 13, comprising a check valve located between the suction port of the aspirator and the device.

15. The turbocharged engine air system in claim 11, wherein the ejector includes a motive port, a discharge port, and a suction port.

16. The turbocharged engine air system in claim 15, wherein the motive port of the ejector is fluidly connected to the intake manifold, the discharge port of the ejector is fluidly connected to atmospheric pressure, and the suction port of the ejector is fluidly connected to the device.

17. The turbocharged engine air system in claim 16, comprising a check valve located between the suction port of the ejector and the device.

18. The turbocharged engine air system in claim 11, wherein the aspirator check valve is fluidly connected to a motive inlet of the aspirator.

19. The turbocharged engine air system in claim 11, wherein the ejector check valve is fluidly connected to a motive inlet of the ejector.

20. The turbocharged engine air system in claim 11, wherein the aspirator includes a bypass port fluidly connected to the device.
